(19) United States
(12) Patent Application Publication
(10) Pub. No.: US 2016/0013455 A1
(43) Pub. Date: Jan. 14, 2016

(54) STACKED-CELL BATTERY WITH NOTCHES TO ACCOMMODATE ELECTRODE CONNECTIONS

(71) Applicant: Apple Inc., Cupertino, CA (US)

(72) Inventors: Brian K. Shiu, Sunnyvale, CA (US); Charles W. Werley, Bethlehem, PA (US); George V. Anastas, San Carlos, CA (US); Richard M. Mank, Los Altos, CA (US)

(21) Appl. No.: 14/799,345

(22) Filed: Jul. 14, 2015

Related U.S. Application Data
(60) Provisional application No. 62/024,395, filed on Jul. 14, 2014.

(51) Int. Cl. H01M 2/02; G06F 1/16; H01M 4/82; H01M 4/70; H01M 2/30; H01M 4/66

(52) U.S. Cl. CPC H01M 2/021; H01M 2/30; H01M 4/661; H01M 4/82; H01M 4/70; G06F 1/1635; H01M 2220/30

(57) ABSTRACT

The disclosed embodiments relate to the design of a stacked-cell battery comprising a stack of layers, including alternating anode and cathode layers coated with active material with intervening separator layers. The stack includes a plurality of notches formed along one or more sides of the stack, including a first notch and a second notch, wherein each cathode layer includes an uncoated cathode tab extending into the first notch, and wherein each anode layer includes an uncoated anode tab extending into the second notch. Moreover, a common cathode tab is bonded to the cathode tabs within the first notch, and a common anode tab is bonded to the anode tabs within the second notch. The stacked-cell battery also includes a pouch enclosing the stack, wherein the common anode and cathode tabs extend through the pouch to provide cathode and anode terminals for the battery cell.

### RELATED APPLICATIONS

This application claims priority under 35 U.S.C. §119 to U.S. Provisional Application No. 62/024,395, entitled “Stacked-Cell Battery with Notches to Accommodate Electrode Connections,” by the same inventors, filed on 14 Jul. 2014.

### BACKGROUND

1. Field

The disclosed embodiments generally relate to batteries for portable electronic devices. More specifically, the disclosed embodiments relate to the design of a stacked-cell battery that includes notches to accommodate connections to electrode tabs that extend from the battery.

2. Related Art

Rechargeable batteries are presently used to provide power to a wide variety of portable electronic devices, including laptop computers, tablet computers, smartphones, and digital music players. To facilitate efficient use of space within these portable electronic devices, designers are beginning to use stacked-cell battery designs, wherein a stacked cell comprises alternating anode and cathode layers covered with active material with intervening separator layers. By varying the dimensions of successive layers in a stack, the resulting battery cell can be formed into various non-rectangular shapes to make efficient use of curved, rounded, and irregularly shaped spaces within various portable electronic devices.

Stacked-cell batteries typically include conductive tabs that are coupled to the anodes and cathodes and extend beyond the outer perimeter of the batteries to provide power to circuitry within the portable electronic device. Unfortunately, connections to these conductive tabs add to the overall profile of the battery cell, which results in wasted space (e.g., space not used by the energy-producing portions of the battery), and thereby decreases the effective energy density of the battery cell.

Hence, what is needed is a stacked-cell battery design that reduces the wasted space caused by connections to conductive tabs that provide power to external circuitry.

### SUMMARY

The disclosed embodiments relate to the design of a stacked-cell battery comprising a stack of layers including alternating anode and cathode layers coated with active material with intervening separator layers. The stack includes a plurality of notches formed along one or more sides of the stack, including a first notch and a second notch, wherein each cathode layer includes an uncoated cathode tab extending into the first notch, and wherein each anode layer includes an uncoated anode tab extending into the second notch. Moreover, a common cathode tab is bonded to the cathode tabs within the first notch, and a common anode tab is bonded to the anode tabs within the second notch. The stacked-cell battery also includes a pouch enclosing the stack, wherein the common anode and cathode tabs extend through the pouch to provide cathode and anode terminals for the battery cell.

In some embodiments, the common cathode tab is bonded to the cathode tabs by: folding the cathode tabs; bonding the folded cathode tabs together; and bonding the common cathode tab to the folded-and-bonded cathode tabs.

In some embodiments, the common anode tab is bonded to the anode tabs by: folding the anode tabs; bonding the folded anode tabs together; and bonding the common anode tab to the folded-and-bonded anode tabs.

In some embodiments, the first and second notches are formed on a same side of the battery cell.

In some embodiments, the first and second notches are formed on adjacent sides of the battery cell.

In some embodiments, the first and second notches are formed on non-adjacent sides of the battery cell.

In some embodiments, the first and second notches comprise either a “contained notch” that is contained within a side of the battery cell, or an “end notch” that extends to an end of a side of the battery cell.

In some embodiments, at least one of the first and second notches comprises a hole in an interior region of the battery cell extending though the layers of the stack, wherein a corresponding conductive tab extends into the hole.

### BRIEF DESCRIPTION OF THE FIGURES

FIG. 1A illustrates a stacked-cell battery in accordance with the disclosed embodiments.

FIG. 1B provides a cross-sectional view of a set of layers for a stacked-cell battery in accordance with the disclosed embodiments.

FIG. 2A illustrates a cathode electrode for a stacked-cell battery in accordance with the disclosed embodiments.

FIG. 2B illustrates an anode electrode for a stacked-cell battery in accordance with the disclosed embodiments.

FIG. 2C illustrates a stack of electrodes in accordance with the disclosed embodiments.

FIGS. 3A-3D illustrate how electrode tabs are folded and bonded to a common electrode tab in accordance with the disclosed embodiments.

FIG. 3E presents a flow chart illustrating the process of folding and bonding electrode tabs to a common electrode tab in accordance with the disclosed embodiments.

FIGS. 4A-4F illustrate a number of possible locations for electrode notches in accordance with the disclosed embodiments.

FIGS. 5A-5D illustrate how electrode notches can take the form of a hole through an interior region of the battery cell in accordance with the disclosed embodiments.

FIG. 6 illustrates a technique for manufacturing a cathode layer in accordance with the disclosed embodiments.

FIG. 7 illustrates another technique for manufacturing a cathode layer in accordance with the disclosed embodiments.

FIG. 8 presents a flow chart illustrating a process for manufacturing a stacked-cell battery in accordance with the disclosed embodiments.

FIG. 9 illustrates a portable computing device including a stacked-cell battery in accordance with the disclosed embodiments.

### DETAILED DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the disclosed embodiments. Thus, the disclosed embodiments are not limited to the embodiments shown, but are to be accorded the widest scope consistent with the principles and features disclosed herein.

### Stacked-Cell Battery

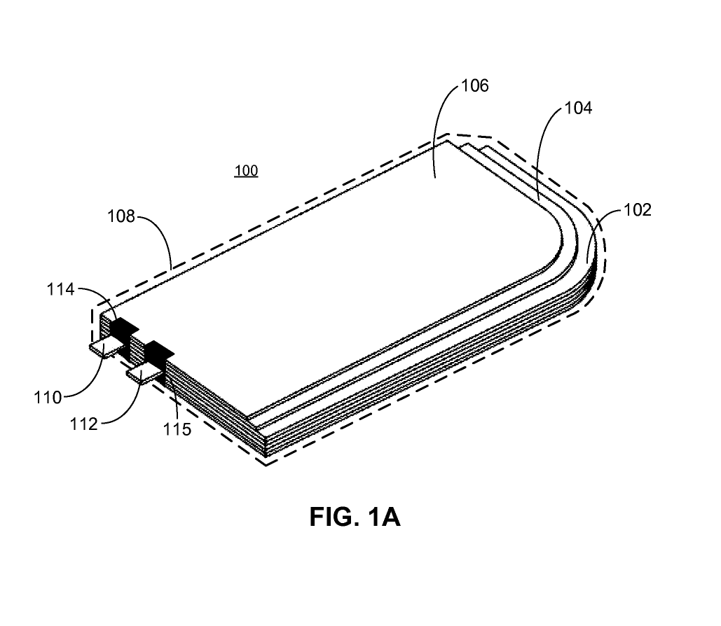

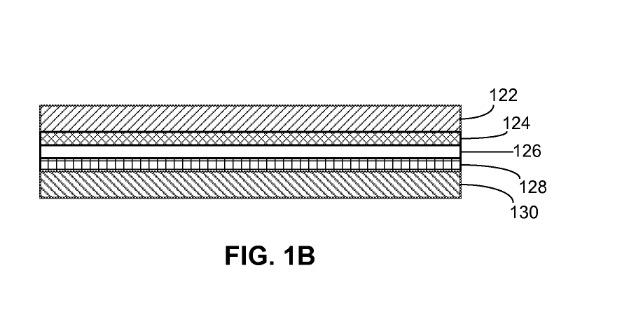

FIG. 1 illustrates a stacked-cell battery 100 in accordance with the disclosed embodiments. Stacked-cell battery 100 may include a lithium-polymer or other suitable cell that supplies power to an electronic device, such as a laptop computer, mobile phone, tablet computer, portable media player, digital camera, and/or other type of battery-powered electronic device.

As shown in FIG. 1, stacked-cell battery 100 includes a number of layers 102-106 that together can form a rectangular or a non-rectangular shape, such as a terraced structure with a rounded corner. Layers 102-106 may include a cathode electrode having a cathode current collector with an active coating (referred to as a “cathode layer”), a separator (referred to as a “separator layer”), and an anode having an anode current collector with an active coating (referred to as an “anode layer”). For example, an adjacent set of layers within layers 102-106 may include one cathode layer (e.g., aluminum foil coated with a lithium compound) and one anode layer (e.g., copper foil coated with carbon) separated by one strip of separator material (e.g., conducting polymer, which may house or otherwise act as an electrolyte).

Each set of layers in the battery may have the same overall size and shape, or different sets of layers may have different shapes and/or sizes to provide a terraced cell. For example, in the variation shown in FIG. 1, the layers may comprise a first group of layers 102, a second group of layers 104, and a third group of layers 106, each group having different dimensions to provide different steps of the terraced cell.

To form the overall shape of the stacked-cell battery 100, layers 102-106 may be cut from sheets of cathode, anode, and/or separator material. For example, layers 102-106 may be formed by cutting substantially rectangular shapes with rounded upper right corners from the sheets of material. Moreover, the sheets of material may be cut so that layers 102-106 have the same shape but the bottommost layers 102 are the largest, the middle layers 104 are smaller, and the topmost layers 106 are the smallest. It should be appreciated that the overall shape of the stacked-cell battery 100 shown in FIG. 1 is exemplary, and any suitable shape may be utilized with the teachings discussed herein.

Layers 102-106 may then be arranged to form the stacked-cell battery 100. For example, layers 102-106 may be formed into sub-cells of different sizes that are stacked to create a non-rectangular shape. Each sub-cell may be a mono-cell containing an anode layer, a cathode layer, and one or more separator layers; a bi-cell containing multiple anode and/or cathode layers with layers of separator sandwiched between the anode and cathode layers; and/or a half-cell containing a separator layer and either an anode or a cathode layer.

After layers 102-106 are formed and stacked, layers 102-106 may be enclosed in a battery housing (e.g., a pouch 108), and a set of conductive tabs 110-112 may be extended through seals in the pouch (for example, formed using sealing tape) to provide terminals for the battery cell. For example, a first conductive tab 110 may be coupled to the cathode(s) of layers 102-106, and a second conductive tab 112 may be coupled to the anode(s) of layers 102-106. Conductive tabs 110-112 may be used to electrically couple the battery cell with one or more other battery cells to form a battery pack. Conductive tabs 110-112 may further be coupled to other battery cells in a series, parallel, or series-and-parallel configuration to form the battery pack. The coupled cells may be enclosed in a hard case to complete the battery pack, or the coupled cells may be embedded within the enclosure of a portable electronic device.

While shown in FIG. 1 as being enclosed in a pouch 108, it should be appreciated that the battery cell may be enclosed in any suitable housing (e.g., a can or the like). In one example, to enclose the battery cell in a pouch 108, layers 102-106 may be placed on top of a flexible sheet made of aluminum with a polymer film, such as polypropylene. Another flexible sheet may then be placed over the tops of layers 102-106, and the two sheets may be heat-sealed and/or folded. Alternatively, layers 102-106 may be placed in between two sheets of pouch material that are sealed and/or folded on some (e.g., non-terminal) sides. The remaining sides(s) may then be heat-sealed and/or folded to enclose layers 102-106 within pouch 108.

In one or more embodiments, the battery cell illustrated in FIG. 1 facilitates efficient use of space within the portable electronic device. For example, the terraced and/or rounded edges of the battery cell may allow the battery cell to fit within a curved enclosure for the portable electronic device. The number of layers (e.g., layers 102-106) may also be increased or decreased to better fit the curvature of the portable electronic device's enclosure. In other words, the battery cell may include an asymmetric and/or non-rectangular design that accommodates the shape of the portable electronic device. In turn, the battery cell may provide greater capacity, packaging efficiency, and/or voltage than rectangular battery cells in the same portable electronic device.

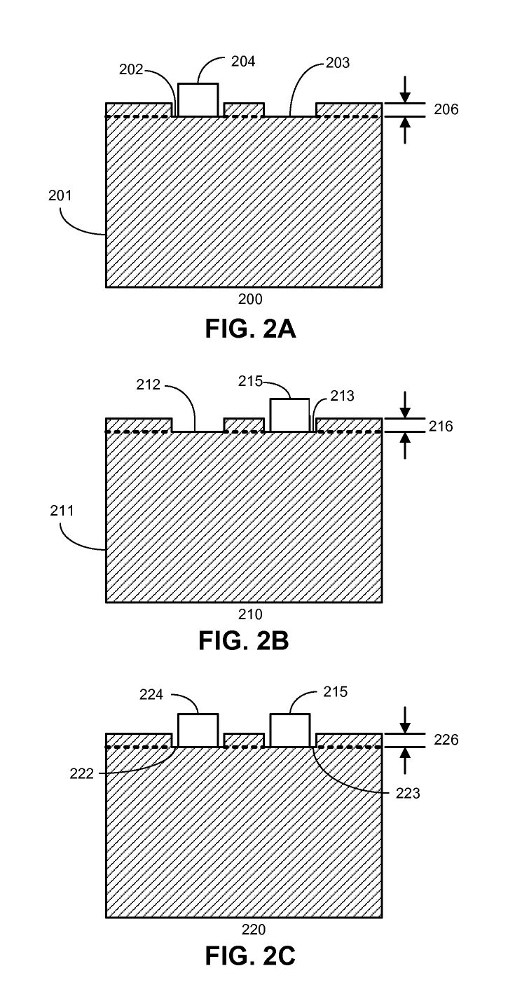

One problem with conventional stack-cell battery designs is that the connections between the anode and cathode layers and conductive tabs 110-112 take up additional space beyond the outer perimeter of the stack of layers 102-106. This additional space is required to bond the electrode layers to conductive tabs 110-112, which may involve connecting individual electrode layers together and bonding the electrode layers to a common conductive tab that provides a terminal for the battery cell. Note that the space taken up by these connections can limit how close the battery housing can be to the sides of the cathode and anode layers. Further, this can require the side of the cathode and/or anode layers of the stacked-cell battery 100 with conductive tabs 110-112 to be spaced away from adjacent components within the electronic device, which wastes space within the electronic device. This problem can be remedied by including one or more notches 114-115 within the stacked-cell battery 100 to accommodate these connections as is described in more detail below with reference to FIGS. 2A-8.

### Layers

FIG. 1B provides a cross-sectional view of a set of layers for a battery cell in accordance with the disclosed embodiments. These layers may include a cathode layer including a cathode current collector 122 and a cathode active coating 124, separator 126, and an anode layer including an anode active coating 128 and an anode current collector 130. The layers may be stacked to form a three-dimensional battery cell such as the battery cell of FIG. 1A.

The layers mentioned above may be formed from any suitable material or materials. For example, in some embodiments, cathode current collector 122 may be a metal foil (e.g, an aluminum foil), cathode active coating 124 may be a lithium compound (e.g., LiCoO₂, LiNCoMn, LiCoAl, LiMn₂O₄) or another suitable cathode active material, anode current collector 130 may be a metal foil (e.g., a copper foil), anode active coating 128 may be carbon, silicon, or another suitable anode active material, and separator 126 may include a polymeric material such as polypropylene and/or polyethylene.

Separator 126 may additionally be a coated separator that includes a micro-alumina (AL₂O₃) and/or other ceramic coating, which can be single-sided or double-sided. This alumina coating is advantageous because it provides the mechanical ruggedness of the alumina, which is about as tough as the LiCoO₂ particles themselves. Moreover, the additional ruggedness provided by the alumina layer may prevent a particle of LiCoO₂ from working its way through separator 126, which can potentially cause a shunt. As a result, the ceramic coating may promote temperature stability in the battery cell and can mitigate faults caused by mechanical stress, penetration, puncture, and/or electrical shorts.

Stacked-Cell Battery with Notches for Electrode Connections

As mentioned above, the stacked-cell battery in FIG. 1A includes one or more notches 114-115 to facilitate bonding electrode layers to battery terminals in a space-efficient manner. These notches may be formed into the individual anode and cathode electrodes prior to assembly of the stack as is illustrated in FIGS. 2A-2B. In particular, FIG. 2A illustrates an exemplary cathode electrode 200 comprising a sheet of current collector material with a coating of active material 201. Cathode electrode 200 includes a cathode notch 202 and an anode notch 203, wherein an uncoated cathode tab 204 extends from the sheet of current collector material into cathode notch 202. Note that providing cathode notch 202 and anode notch 203 to make space for connections to the electrode layers, which allows the cathode electrode 200 to include additional active material 206, which effectively increases the energy density of the battery cell.

Similarly, FIG. 2B illustrates an exemplary anode electrode 210 comprising a sheet of current collector material with a coating of active material 211. Anode electrode 210 also includes a cathode notch 212 and an anode notch 213, wherein an uncoated anode tab 215 extends from the sheet of current collector material into anode notch 213. Providing cathode notch 212 and anode notch 213 to make space for connections to the electrode layers allows the anode electrode 210 to include additional active material 216.

Finally, FIG. 2C illustrates stack of electrodes 220 including cathode tabs 224 in cathode notch 222 and anode tabs 215 in anode notch 223, wherein cathode and anode notches 222-223 provide space for electrode connections, which allows the stack of electrodes 220 to include additional active material 226.

### Bonding Electrode Tabs

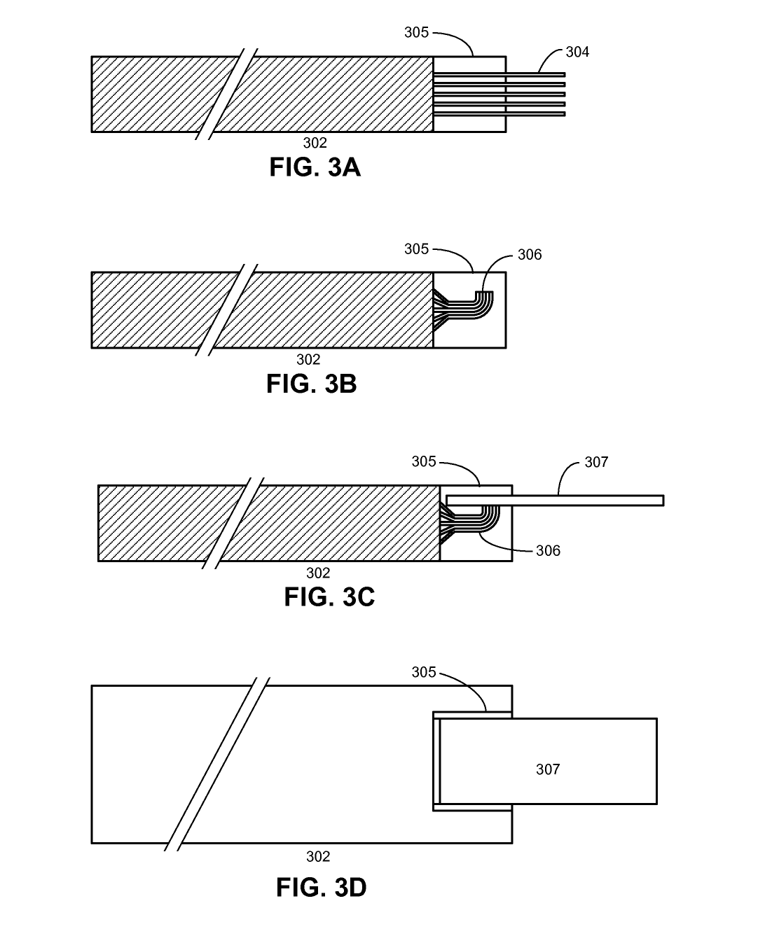

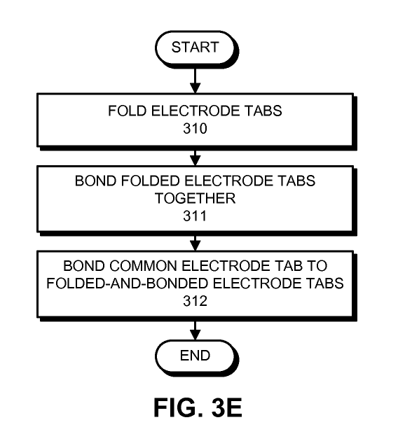

As mentioned above, the additional space provided by notches 114-115 in FIG. 1A can be used to make connections between the individual electrode layers and the common tabs that serve as battery terminals. This can be accomplished through a number of manufacturing steps as is illustrated in FIGS. 3A-3E. The process starts after the various electrode and separator layers have been assembled into a stack 302 as is illustrated in FIG. 3A. FIG. 3A provides a cross-sectional view of stack 302 that includes a notch 305, wherein electrode tabs 304 extend from stack 302 through notch 305. Note that notch 305 may be either a cathode notch or an anode notch, and electrode tabs 304 are either corresponding cathode tabs or anode tabs. The first two manufacturing steps involve folding and bonding electrode tabs 304 to produce folded-and-bonded electrode tabs 306 as is illustrated in FIG. 3B. Next, a common tab 307, which can be either a common cathode tab or a common anode tab, is bonded to folded-and-bonded electrode tabs 306. Common tab 307 extends from the battery cell to provide a positive or negative terminal for the battery cell as is illustrated in FIG. 3C. (FIG. 3D provides a corresponding top view of the configuration illustrated in FIG. 3C.) In some embodiments, the common tab may be connected to the electrode tabs within the notch and may extend out of the notch. (Note that the connection between the electrode tabs and the common tabs may take place entirely within the notch, partially within the notch, or outside the notch.) This common tab may extend out of the battery housing to different locations with a housing of an electronic device, or to different locations within a battery enclosure (e.g., in an instances where multiple batteries are housed and/or connected within a common battery enclosure).

It should be appreciated that although the notches are formed in one or more sides of the electrode, the battery housing (and thus the overall battery cell) may not include notches corresponding to the notches of the electrode. Indeed, by connecting the electrode tabs at least partially within the notches (and thereby at least partially filling the notches), the battery housing may follow the overall profile of the electrodes, and may do so with a reduced footprint relative to batteries in which the cathode and/or anode tabs extend from an outer perimeter of the electrode.

FIG. 3E presents a flow chart illustrating the process of folding and bonding electrode tabs to a common electrode tab in accordance with the disclosed embodiments. First, the electrode tabs are folded (step 310). Next, the folded electrode tabs are bonded together, for example through ultrasonic welding (step 311). Finally, the folded-and-bonded electrode tabs are bonded to the common electrode tab (step 312). Please note that the above-listed sequence of steps are described as taking place in a specific order. However, these steps can alternatively be performed in other possible orderings.

Although FIGS. 3A-3E illustrate a specific technique for connecting the electrode tabs to a common electrode tab within a notch, the disclosed embodiments are not meant to be limited to this specific technique. In general, any effective technique can be used to connect the electrode tabs to the common tab within the notch. Moreover, in some cases, portions of the connection may extend outside of the notch.

### Locations for Notches

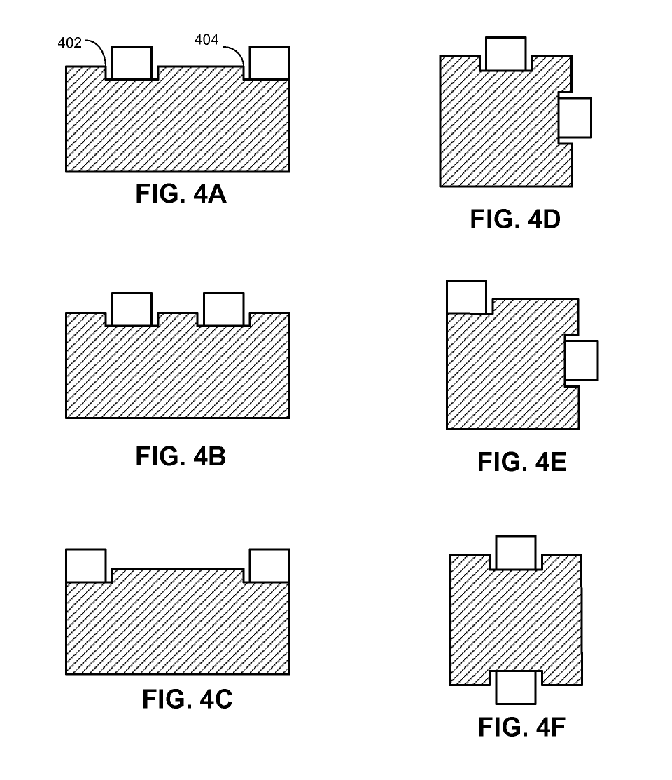

FIGS. 4A-4F illustrate a number of possible locations for electrode notches in accordance with the disclosed embodiments. As illustrated in FIG. 4A, the notches can include: (1) a “contained notch” 402 that is contained within a side of the battery cell, or (2) an “end notch” 404 that extends to an end of a side of the battery cell. FIG. 4A illustrates the case of an end notch and a contained notch on the same side of a battery cell. FIG. 4B illustrates the case of two contained notches on the same side of a battery cell, and FIG. 4C illustrates the case of two end notches on the same side of a battery cell.

Notches can also be positioned on different sides of a battery cell. For example, FIG. 4D illustrates the case of two contained notches on adjacent sides of a battery cell, and FIG. 4E illustrates the case of an end notch on one side of a battery cell and a contained notch on an adjacent side of a battery cell. In other instances, a cell may include two edge notches on adjacent sides of a battery cell. Finally, FIG. 4F illustrates the case of two contained notches on non-adjacent sides of a battery cell. In some instances case, the non-adjacent sides may be directly opposite each other (e.g., opposite sides of a rectangle, hexagon, etc.). However, in other instances (e.g., when the cell is a heptagon, hexagon, irregularly shaped or the like, the non-adjacent sides may not necessarily be opposite each other. While the battery is shown in FIG. 4F as including two contained notches on non-adjacent sides, it should be appreciated that in other variations the battery cell may include two edge notches on non-adjacent sides, or an edge notch and a contained notch on non-adjacent sides.

### Holes for Electrode Tabs

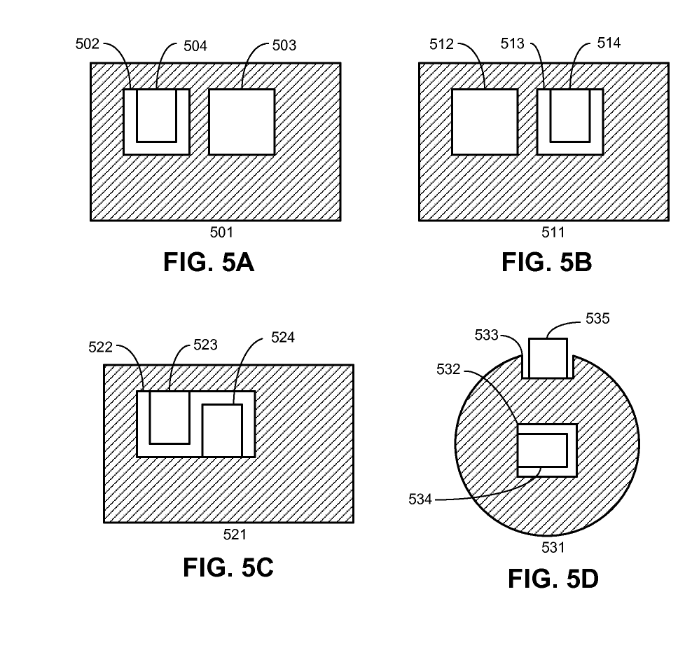

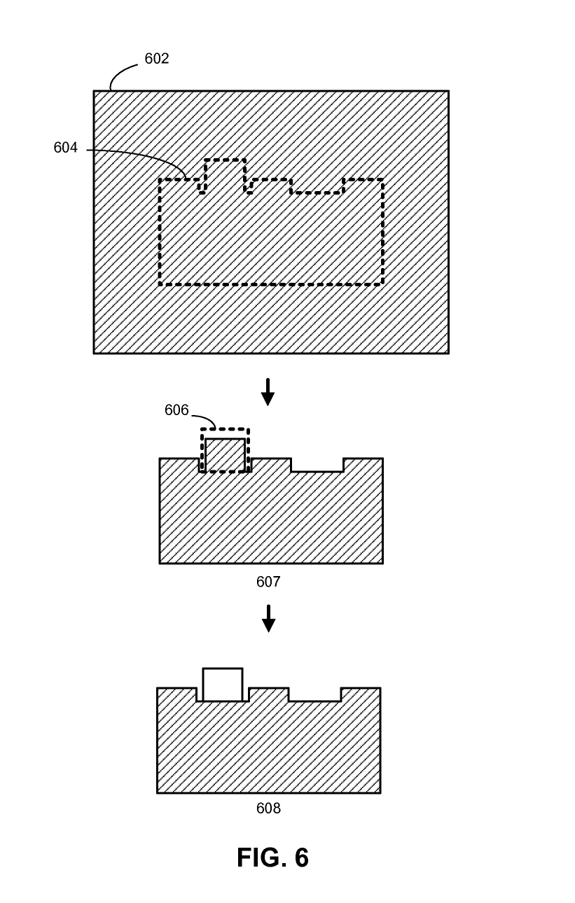

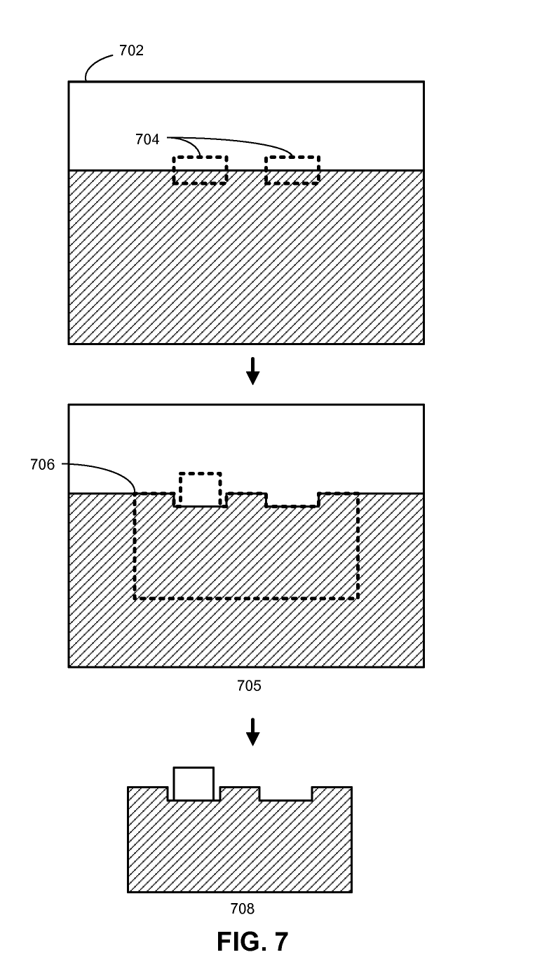

FIGS. 5A-5D illustrate variations in which one or more of the notches is replaced by a hole through an interior region of the battery cell. More specifically, FIG. 5A illustrates a cathode electrode 501 that includes two holes 502 and 503, wherein hole 502 includes an uncoated cathode tab 504, and wherein hole 503 exists to allow tabs to form corresponding anode electrodes to connect with each other. Similarly, FIG. 5B illustrates a corresponding anode electrode 511 with matching holes 512 and 513, wherein hole 513 includes an uncoated anode tab 514, and wherein hole 512 exists to allow tabs to form corresponding cathode electrodes to connect with each other. Note that a battery cell stack can be formed by stacking alternating cathode and anode electrodes (including holes) with intervening separator layers, wherein the cathode electrodes are connected with each other through one hole, and the anode electrodes are connected with each other through the other hole.

FIG. 5C illustrates a stack 521 with a single hole 522 that accommodates both cathode tabs 523 and anode tabs 524. Finally, FIG. 5D illustrates a stack of circular electrodes 531, including a hole 532 for accommodating cathode tabs 534, and a notch 533 for accommodating anode tabs 535.

### Electrode Manufacturing Techniques

The above-described electrodes (also referred to as “layers”) with notches and conductive tabs can be manufactured using a number of different techniques. For example, FIG. 6 illustrates how a cathode layer can be manufactured in accordance with the disclosed embodiments. The process starts with a sheet of current collector material that is coated with an active material 602 chosen for the cathode layer. The first step is to perform a cutting operation 604 based on an outline for the cathode layer as is illustrated by the dotted line at the top of FIG. 6. (For example, this cutting operation can involve using a laser-based cutting technique or a plasma cutting technique.) The cutting operation produces an intermediate cathode layer 607. Next, an ablation operation is performed 606 on the intermediate cathode layer 607 to remove the active coating from the cathode tab. This produces a final cathode layer 608 with an uncoated cathode tab. Note that the ablation operation 606 can alternatively be performed before cutting operation 604 takes place.

FIG. 7 illustrates an alternative technique for manufacturing a cathode layer in accordance with the disclosed embodiments. This technique also starts with a sheet of electrode material coated with an active material 702. However, the active material only covers a portion of the sheet as is illustrated at the top of FIG. 7. Next, areas in the sheet 702 where the notches will be cut are ablated 704 to produce an ablated sheet 705. (Instead of cutting/ablating the notches, the coating may be deposited in a pattern that includes notches.) Then, a cutting operation 706 is performed to produce a finished cathode layer 708.

Although FIGS. 6 and 7 describe techniques for manufacturing cathode layers with notches, the same techniques can be easily modified to manufacture corresponding anode electrodes with notches. In these instances, the techniques would be done using a current collector material and active material selected for the anode.

### Process for Manufacturing a Stacked-Cell Battery

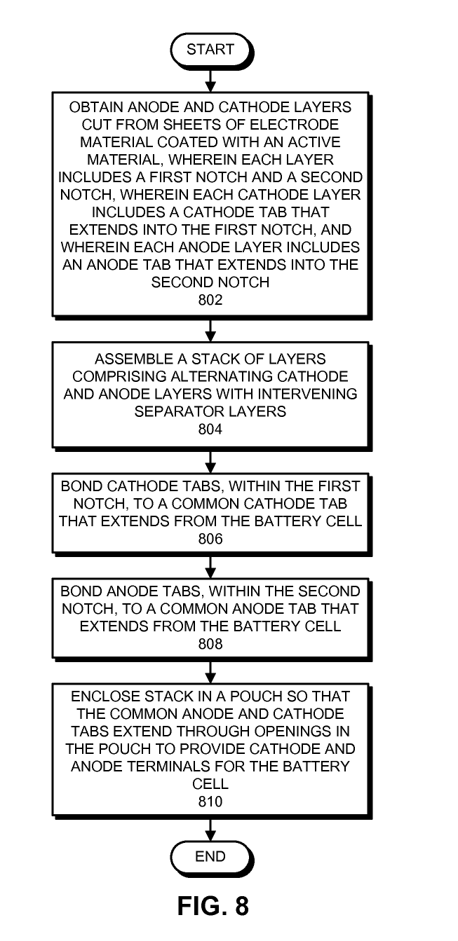

FIG. 8 presents a flow chart illustrating a process for manufacturing a stacked-cell battery in accordance with the disclosed embodiments. This process assumes that the cathode and anode layers have already been manufactured, for example using techniques illustrated in FIGS. 6 and 7.

At the start of this process, the system obtains the cathode and anode layers that have been cut from sheets of current collector material coated with an active material (the cathode layers are cut from sheets of cathode current collector material coated with a cathode active material while the anode layers are cut from sheets of anode current collector material coated with an anode active material), wherein each layer includes a first notch and a second notch. Moreover, each cathode layer includes a cathode tab that extends into the first notch, and each anode layer includes an anode tab that extends into the second notch (step 802). Next, the system assembles a stack of layers comprising alternating cathode and anode layers with intervening separator layers (step 804). After the stack has been assembled, the system bonds the cathode tabs, within the first notch, to a common cathode tab that extends from the battery cell (step 806). The system also bonds the anode tabs, within the second notch, to a common anode tab that extends from the battery cell (step 808). Finally, the system encloses the stack in a pouch, so that the common anode and cathode tabs extend through openings in the pouch to provide cathode and anode terminals for the battery cell (step 810).

### Computing Device

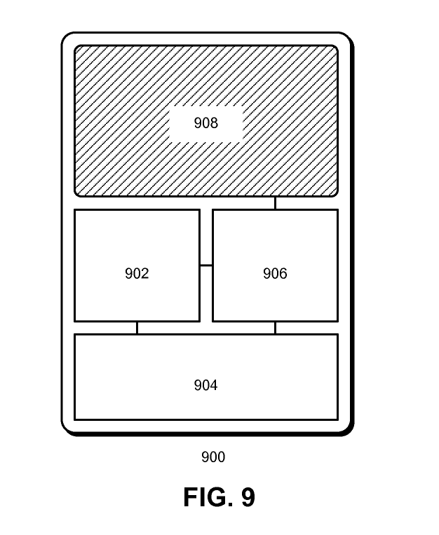

The above-described rechargeable battery cell can generally be used in any type of electronic device. For example, FIG. 9 illustrates a portable electronic device 900, which includes a processor 902, a memory 904 and a display 908, which are all powered by a battery 906. Portable electronic device 900 may correspond to a laptop computer, mobile phone, tablet computer, portable media player, digital camera, and/or other type of battery-powered electronic device. Battery 906 may correspond to a battery pack that includes one or more battery cells. Each battery cell may include a set of layers sealed in a pouch, including a cathode with an active coating, a coated separator, an anode with an active coating, and/or a binder coating.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A battery cell, comprising:
a stack of layers comprising alternating anode and cathode layers coated with active material with intervening separator layers;
a plurality of notches formed along one or more sides of the stack, including a first notch and a second notch, wherein each cathode layer includes an uncoated cathode tab extending into the first notch, and wherein each anode layer includes an uncoated anode tab extending into the second notch;
a common cathode tab bonded to the cathode tabs within the first notch; and
a common anode tab bonded to the anode tabs within the second notch.

2. The battery cell of claim 1, further comprising a pouch enclosing the stack, wherein the common anode and cathode tabs extend through the pouch to provide cathode and anode terminals for the battery cell.

3. The battery cell of claim 1, wherein the bond between the common cathode tab and the cathode tabs includes folded-and-bonded cathode tabs that are bonded to the common cathode tab.

4. The battery cell of claim 1, wherein the bond between the common anode tab and the anode tabs includes folded-and-bonded anode tabs that are bonded to the common anode tab.

5. The battery cell of claim 1, wherein the first and second notches are positioned on a same side of the battery cell.

6. The battery cell of claim 1, wherein the first and second notches are positioned on adjacent sides of the battery cell.

7. The battery cell of claim 1, wherein the first and second notches are positioned on non-adjacent sides of the battery cell.

8. The battery cell of claim 1, wherein either of the first and second notches can comprise one of the following:
a contained notch that is contained within a side of the battery cell; and
an end notch that extends to an end of a side of the battery cell.

9. The battery cell of claim 1, further comprising a hole in an interior region of the battery cell extending though the layers of the stack, wherein a corresponding conductive tab extends into the hole.

10. An electrode for a stacked battery cell, comprising:
a layer of current collector material coated with an active material;
wherein the layer comprises a first notch and a second notch; and
wherein the layer comprises an uncoated tab that extends into the first notch.

11. The electrode of claim 10, wherein the first notch and the second notch are positioned on a same side of the electrode.

12. The electrode of claim 10, wherein the first notch and the second notch are positioned on adjacent sides of the electrode.

13. The electrode of claim 10, wherein the first notch and the second notch are positioned on non-adjacent sides of the electrode.

14. The electrode of claim 10, wherein either of the first notch and the second notch can comprise one of the following:
a contained notch that is contained within a side of the electrode; and
an end notch that extends to an end of a side of the electrode.

15. The electrode of claim 10, wherein at least one of the first notch and the second notch comprises a hole in an interior region of the electrode.

16. A method for manufacturing a battery cell, comprising:
cutting anode and cathode layers from sheets of current collector material coated with an active material, so that each layer includes a plurality of notches including a first notch and a second notch, wherein each cathode layer includes a cathode tab that extends into the first notch, and wherein each anode layer includes an anode tab that extends into the second notch;
ablating the coating of active material from regions of the current collector material associated with the cathode tab and the anode tab;
forming a stack of layers comprising alternating cathode and anode layers with intervening separator layers;
bonding the cathode tabs, within a recess formed by the first notches in the anode and cathode layers, to a common cathode tab that extends from the battery cell; and
bonding the anode tabs, within a recess formed by the second notches in the anode and cathode layers, to a common anode tab that extends from the battery cell.

17. The method of claim 16, further comprising placing the stack in a pouch so that the common anode and cathode tabs extend through openings in the pouch to provide cathode and anode terminals for the battery cell.

18. The method of claim 16, wherein the coating of active material is ablated prior to cutting the anode and cathode layers.

19. The method of claim 16, wherein the coating of active material is ablated after cutting the anode and cathode layers.

20. The method of claim 16, wherein bonding the cathode tabs to the common cathode tab includes:
folding the cathode tabs;
bonding the folded cathode tabs together; and
bonding the common cathode tab to the folded-and-bonded cathode tabs.

21. The method of claim 16, wherein bonding the anode tabs to the common anode tab includes:
folding the anode tabs;
bonding the folded anode tabs together; and
bonding the common anode tab to the folded-and-bonded anode tabs.

22. The method of claim 16, wherein the first and second notches are formed on a same side of the battery cell.

23. The method of claim 16, wherein the first and second notches are formed on adjacent sides of the battery cell.

24. The method of claim 16, wherein the first and second notches are formed on non-adjacent sides of the battery cell.

25. The method of claim 16, wherein the first and second notches comprise one of the following:
a contained notch that is contained within a side of the battery cell; and
an end notch that extends to an end of a side of the battery cell.

26. The method of claim 16,
wherein at least one of the first and second notches comprises a hole in an interior region of the battery cell extending though the layers of the stack; and
wherein a corresponding conductive tab extends into the hole.

27. A method for manufacturing a battery cell, comprising:
forming a coating of active material on one or more sheets of current collector material so that each sheet has a coated region and an uncoated region;
forming a plurality of notches in the coating along a border between the coated region and an uncoated region in the one or more sheets of current collector material;
cutting anode and cathode layers from the one or more sheets of current collector material, wherein each cathode and anode layer is cut to include a plurality of notches including a first notch and a second notch, wherein each cathode layer includes a cathode tab that extends into the first notch, wherein each anode layer includes an anode tab that extends into the second notch, and wherein the plurality of notches in the cathode and anode layers match corresponding notches in the coating;
forming a stack of layers comprising alternating cathode and anode layers with intervening separator layers;
bonding the cathode tabs, within a recess formed by the first notches in the anode and cathode layers, to a common cathode tab that extends from the battery cell; and
bonding the anode tabs, within a recess formed by the second notches in the anode and cathode layers, to a common anode tab that extends from the battery cell.

28. The method of claim 27, further comprising placing the stack in a pouch so that the common anode and cathode tabs extend through openings in the pouch to provide cathode and anode terminals for the battery cell.

29. The method of claim 27, wherein bonding the cathode tabs to the common cathode tab includes:
folding the cathode tabs;
bonding the folded cathode tabs together; and
bonding the common cathode tab to the folded-and-bonded cathode tabs.

30. The method of claim 27, wherein bonding the anode tabs to the common anode tab includes:
folding the anode tabs;
bonding the folded anode tabs together; and
bonding the common anode tab to the folded-and-bonded anode tabs.

31. The method of claim 27, wherein the first and second notches are formed on a same side of the battery cell.

32. The method of claim 27, wherein the first and second notches are formed on adjacent sides of the battery cell.

33. The method of claim 27, wherein the first and second notches are formed on non-adjacent sides of the battery cell.

34. The method of claim 27, wherein the first and second notches comprise one of the following:
a contained notch that is contained within a side of the battery cell; and
an end notch that extends to an end of a side of the battery cell.

35. The method of claim 27,
wherein at least one of the first and second notches comprises a hole in an interior region of the battery cell extending though the layers of the stack; and
wherein a corresponding conductive tab extends into the hole.

36. A portable computing device, comprising:
a processor;
a memory;
a display; and
a stacked-cell battery comprising:
a stack of layers comprising alternating anode and cathode layers coated with active material with intervening separator layers;
a plurality of notches formed along one or more sides of the stack, including a first notch and a second notch, wherein each cathode layer includes an uncoated cathode tab extending into the first notch, and wherein each anode layer includes an uncoated anode tab extending into the second notch;
a common cathode tab bonded to the cathode tabs within the first notch;
a common anode tab bonded to the anode tabs within the second notch; and
a pouch enclosing the stack, wherein the common anode and cathode tabs extend through the pouch to provide cathode and anode terminals for the battery cell.

37. A battery cell, comprising:
a housing;
a stack of electrode layers positioned within the housing; and
a first common electrode tab extending from said housing,
wherein the stack of electrode layers comprises at least one anode layer and at least one cathode layer,
wherein the stack of electrode layers comprises a first notch positioned along a first side of the stack,
wherein the first common electrode tab is connected to the at least one anode layer or the at least one cathode layer within the notch and extends from the notch within the housing.

38. The battery cell of claim 37, wherein the housing is a pouch.

39. A method for manufacturing an electrode for a battery cell, comprising:
cutting an electrode layer from sheets of current collector material coated with an active material, so that the electrode layer includes a first notch and a second notch, wherein the electrode layer includes a tab that extends into the first notch;
ablating the coating of active material from regions of the current collector material associated with the tab.

40. The method of claim 39, wherein the coating of active material is ablated prior to cutting the electrode layer.

41. The method of claim 22, wherein the coating of active material is ablated after cutting the electrode layer.
